(19) United States
(12) Patent Application Publication
(10) Pub. No.: US 2007/0155586 A1
(43) Pub. Date: Jul. 5, 2007

(54) Accelerator pedal operation device

(76) Inventor: Yasutoshi Kurokawa, Tokyo (JP)

Correspondence Address: Jacobson Holman PLLC, 400 Seventh Street, N.W., Washington, DC, 20004, US

(21) Appl. No.: 11/603,206

(22) Filed: Nov. 22, 2006

Related U.S. Application Data
(63) Continuation of application No. PCT/JP06/05587, filed on Mar. 20, 2006.

(30) Foreign Application Priority Data
Mar. 23, 2005 (JP) 2005-083574

(51) Int. Cl. B60W 10/04

(52) U.S. Cl. 477/115

(57) ABSTRACT

The pedal lever has a boss portion which acts as a center of rotation, and a first lever and a second lever which extend from the boss portion in two directions, wherein the reverse lever is coupled with an extending extreme end portion of the first lever, and the accelerator pedal is coupled with an extending extreme end portion of the second lever, and an operation unit is arranged on a side opposite to the extending extreme end portion across the boss portion, the operation unit operating the accelerator switch.

### CROSS-REFERENCE TO RELATED APPLICATIONS

This is a Continuation Application of PCT Application No. PCT/JP2006/305587, filed Mar. 20, 2006, which was published under PCT Article 21(2) in Japanese.

This application is based upon and claims the benefit of priority from prior Japanese Patent Application No. 2005-083574, filed Mar. 23, 2005, the entire contents of which are incorporated herein by reference.

### BACKGROUND OF THE INVENTION

1. Field of the Invention

The present invention relates to an accelerator pedal operation device for transmitting an amount of depression of an accelerator pedal to an accelerator stroke sensor.

2. Description of the Related Art

Ordinarily, in vehicles and the like on which an electronically controlled engine is mounted, an amount of depression of an accelerator pedal is transmitted to an accelerator stroke sensor, an electronic signal corresponding to the amount of depression of the accelerator pedal is generated, and an engine is controlled in response to the electronic signal.

Conventionally, a cable has been used as means for transmitting the amount of depression of the accelerator pedal to the accelerator stroke sensor.

Ordinarily, the accelerator pedal is installed in a front narrow portion on a floor of a driver's cabin. For this reason, when the cable is employed as the means, a job for wiring and connecting the cable is troublesome and an efficiency of the job is deteriorated. Further, since there is a possibility of breakage and the like in the transmission means composed of the cable, its reliability is low.

Accordingly, recently, a system for transmitting an amount of depression of an accelerator pedal to an accelerator stroke sensor through a link mechanism is employed as found in, for example, Jpn. Pat. Appln. KOKAI Publication No. 7-150987.

### BRIEF SUMMARY OF THE INVENTION

Incidentally, an accelerator pedal is provided with an accelerator switch for detecting whether or not the accelerator pedal is depressed. Conventionally, since the accelerator switch has been arranged on a floor of a driver's cabin adjacent to the accelerator pedal, not only an accelerator switch assembly job is troublesome but also the accelerator switch may stand in the way of operation of the accelerator pedal.

An object of the present invention, which has been made in view of the above point, is to provide an accelerator pedal operation device in which an accelerator switch can be easily and effectively installed in a narrow space of a driver's cabin together with a link mechanism such that the accelerator switch does not disturb operation of the accelerator pedal at all.

In an accelerator pedal operation device according to an aspect of the present invention having a pedal lever which turns in response to depression of an accelerator pedal, a link mechanism having a reverse lever, which turns in association with the pedal lever, and is arranged as a unit structure, an accelerator stroke sensor which detects an amount of rotation of the reverse lever of the link mechanism and controls an amount of fuel injected into an engine, and an accelerator switch assembled to the link mechanism integrally therewith, the accelerator switch detecting whether or not the accelerator pedal is depressed in association with the pedal lever.

A preferred aspect of the present invention wherein the pedal lever having a boss portion which acts as a center of rotation, and a first lever and a second lever which extend from the boss portion in two directions, wherein the reverse lever is coupled with an extending extreme end portion of the first lever, and the accelerator pedal is coupled with an extending extreme end portion of the second lever, and an operation unit is arranged on a side opposite to the extending extreme end portion across the boss portion, the operation unit operating the accelerator switch.

Further, a preferred aspect of the present invention wherein the accelerator switch is arranged so as to move with respect to the link mechanism so that a position of the accelerator switch can be adjusted with respect to the operation unit of the pedal lever.

### BRIEF DESCRIPTION OF THE SEVERAL VIEWS OF THE DRAWING

FIG. 1 is a side elevational view showing an accelerator pedal device according to an embodiment of the present invention.

FIG. 2 is a side elevational view showing a state in which an accelerator pedal of the accelerator pedal device is depressed.

FIG. 3 is a perspective view showing a link mechanism of the accelerator pedal device.

FIG. 4 is a side elevational view showing an accelerator switch of the accelerator pedal device.

### DETAILED DESCRIPTION OF THE INVENTION

An embodiment of the present invention will be described with reference to the drawings.

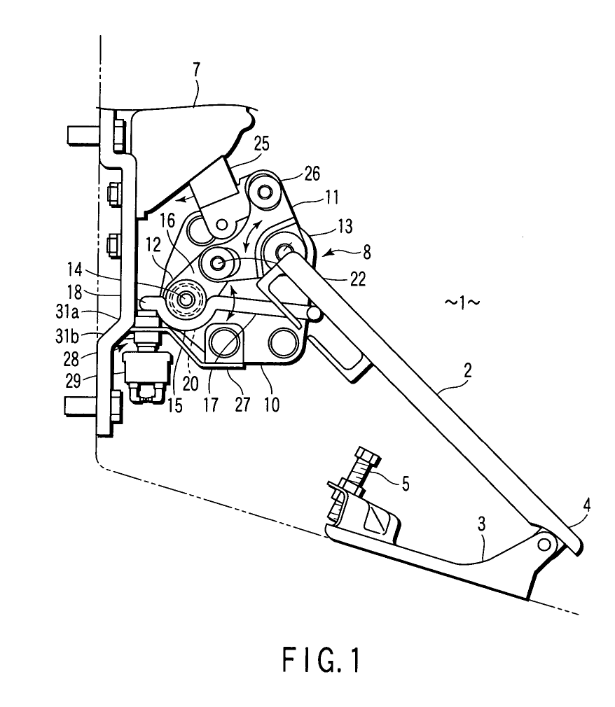

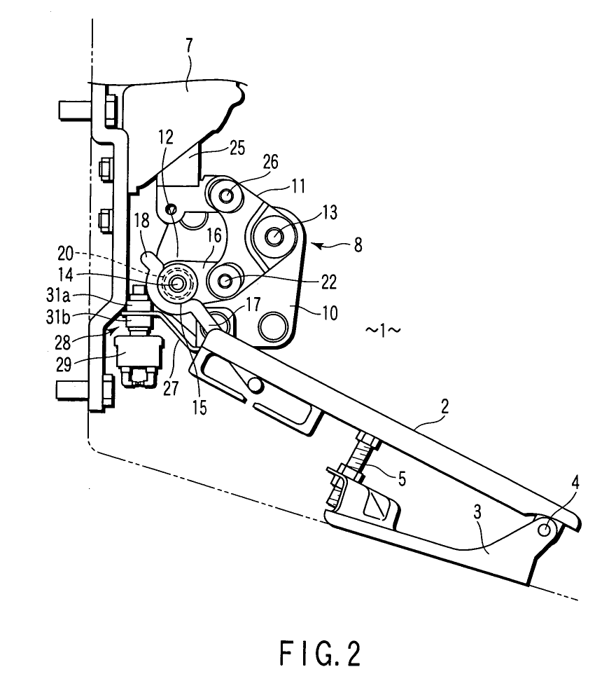

As shown in FIGS. 1 and 2, a pedal holder 3 having an accelerator pedal 2 is installed on a floor of a driver's cabin 1 of a vehicle. An end of the accelerator pedal 2 on one end side is upward and downward turnably attached to the pedal holder 3 through a shaft 4. The pedal holder 3 is provided with a stopper 5 for adjusting a maximum stroke width of depression of the accelerator pedal 2.

Note that FIG. 1 shows a state before the accelerator pedal 2 is depressed, and FIG. 2 shows a state when the accelerator pedal 2 is depressed up to the maximum stroke width.

An accelerator stroke sensor 7 and a link mechanism 8 associating with the accelerator stroke sensor 7 are arranged to a front upper portion of the driver's cabin 1. As shown in FIGS. 1, 2, and 3, the link mechanism 8 has a base 10, and a reverse lever 11 and a pedal lever 12 are turnably attached to the base 10 through shafts 13, 14, respectively, thereby an integral unit structure is constructed.

The reverse lever 11 is bent to a C-shape, the shaft 13 is inserted into the bent portion, and the reverse lever 11 turns about the shaft 13. The pedal lever 12 has a boss portion 15, the shaft 14 is inserted into the boss portion 15, and the boss portion 15 turns about the shaft 14.

A first lever 16 extends in one direction and a second lever 17 extends in the other direction from the boss portion 15 integrally therewith, respectively. Further, a projecting-piece-like operation unit 18 is arranged to a side opposite to the second lever 17 with respect to the boss portion 15 integrally with the second lever 17 so as to extend in a direction opposite to the second lever 17.

A spring 20 is assembled to the boss portion 15, and the pedal lever 12 is elastically urged by the spring 20 counterclockwise in the figure in its entirety.

The end of the first lever 16 of the pedal lever 12 on an extreme end side is coupled with an end of the reverse lever 11 on one end side through a pin 22. The pin 22 is attached to the end of the first lever 16 and loosely fitted to a slot (not shown) formed to the end of the reverse lever 11. Consequently, the reverse lever 11 is turned about the shaft 13 in response to the turn of the pedal lever 12.

The second lever 17 of the pedal lever 12 extends into the driver's cabin 1, the end of the accelerator pedal 2 on a free end side is placed on and fitted to the end of the second lever 17 on an extreme end side, and the pedal lever 12 is turned in response to depression of the accelerator pedal 2.

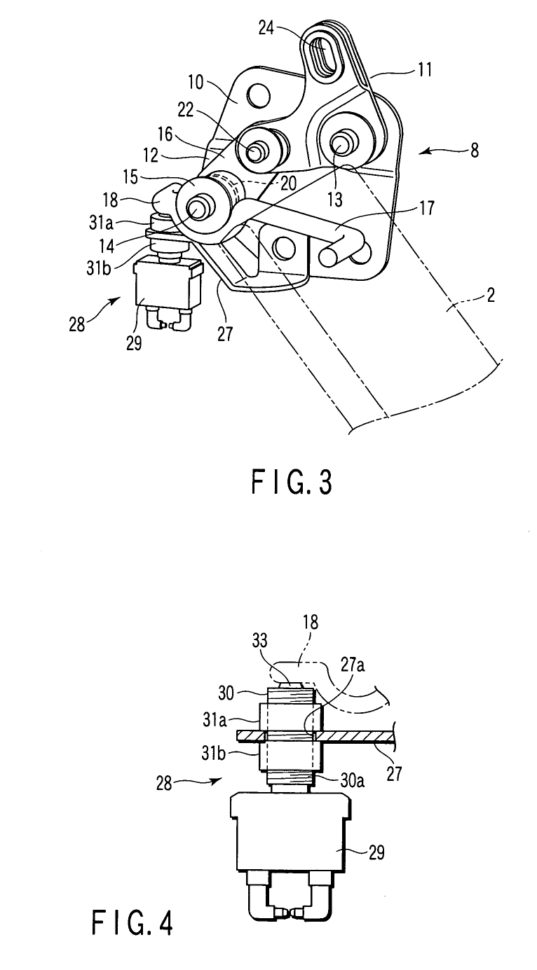

The accelerator stroke sensor 7 has a swingable operation lever 25, and an end of the operation lever 25 is turnably coupled with an end of the reverse lever 11 on the other side through a pin 26. The pin 26 is attached to the end of the operation lever 25 and loosely fitted to a slot 24 formed to an end of the reverse lever and shown in FIG. 3. Consequently, the operation lever 25 is swung in response to the turn of the reverse lever 11.

A bracket 27 is attached to the base 10 of the link mechanism 8, and an accelerator switch 28 is attached to the bracket 27 so as to confront with the operation unit 18 of the pedal lever 12.

As shown in FIG. 4, the accelerator switch 28 has a shaft portion 30 extending from an upper portion of a main body 29 upward together with it, and the shaft 30 is inserted into a through hole 27a formed to an end of the bracket 27 from under it.

A screw 30a is formed around the outer peripheral surface of the shaft portion 30, a pair of nuts 31a, 31b are screwed on the screw 30a, these nuts 31a, 31b are arranged on and under the bracket 27 so as to clamp it, and the accelerator switch 28 is tightly attached to the bracket 27 by tightening these nuts 31a, 31b and supported, so that the height of it is set to a predetermined level. The level of the height can be changed by loosening the nuts 31a and 31b.

The accelerator switch 28 has a switch button 33 at an upper end portion of the shaft portion 30, and the switch button 33 is urged so as to elastically project upward and arranged so as to confront with the operation unit 18 of the pedal lever 12.

Note that the accelerator stroke sensor 7 and the accelerator switch 28 are electrically connected to an engine control unit (not shown) for controlling an amount of fuel injected into an engine.

In a free state in which the accelerator pedal 2 is not depressed, the operation unit 18 comes into contact with the switch button 33 of the accelerator switch 28 by elastic force of the spring 20 assembled to the boss portion 15 of the pedal lever 12, thereby the switch button 33 is pushed downward with predetermined pressure and the accelerator switch 28 is kept in a turned on state.

When the accelerator pedal 2 is depressed downward from the engine idling state, the pedal lever 12 is turned clockwise in the figure about the shaft 14 against the spring 20. Thereby, the operation unit 18 of the pedal lever 12 is released from the switch button 33 of the accelerator switch 28. The switch button 33 is switched from the turn on state to a turn off state, thereby depression of the accelerator pedal 2 is detected, and a signal of depression is sent to the engine control unit.

Further, the reverse lever 11 is turned counterclockwise about shaft 13 in association with the clockwise turning operation of the pedal lever 12 and the operation lever 25 of the accelerator stroke sensor 7 is swung by the turning operation, thereby an amount of turn of the reverse lever 11 is detected, and a signal of detection is sent to the engine control unit.

Since the signal from the accelerator switch 28 and the signal from the accelerator stroke sensor 7 are sent to the engine control unit as described above, an amount of fuel injected into the engine is controlled through the engine control unit.

An amount of depression of the accelerator pedal 2 is proportional to an amount of swing of the operation lever 25 of the accelerator stroke sensor 7 and the operation lever 25 is swung at a stroke according to an amount of depression of the accelerator pedal 2, thereby the amount of fuel injected into the engine is controlled to a proper amount.

Incidentally, when the stroke sensor 7 does not act normally due to a fault and a predetermined signal is not output regardless of whether the accelerator pedal 2 is depressed and a signal of the accelerator switch 28 is output to the engine control unit therefrom, the amount of fuel injected into the engine is adjusted to such a degree as to cause the vehicle to travel at a very slow speed under the control of the engine control unit.

As described above, the accelerator switch 28 is a member for detecting whether or not the accelerator pedal 2 carries out a depression operation. However, in the embodiment, the accelerator switch 28 is assembled to the link mechanism 8 integrally with it and arranged to the front portion of the driver's cabin 1 spaced apart from the accelerator pedal 2, and therefore, it does not disturb operation of the accelerator pedal 2 at all.

Further, the accelerator switch 28 is assembled to the link mechanism 8, which transmits the stroke of the accelerator pedal 2 to the accelerator stroke sensor 7, integrally with it and arranged as a unit. Accordingly, it is not necessary to carry out a troublesome job for attaching the accelerator switch 28 to a narrow space in the driver's cabin 1 as a single unit, and it can be easily and effectively installed in the driver's cabin 1 together with the link mechanism 8.

The accelerator switch 28 must be arranged at a position having a predetermined proper height based on the pedal lever 12 as a standard. That is, it is important to adjust the operation unit 18 of the pedal lever 12 such that it properly comes into contact with the switch button 33 of the accelerator switch 28 in idling as well as being securely released therefrom when the accelerator pedal 2 begins to be depressed. However, the operation unit 18 can be easily adjusted by moving the shaft portion 30 up and down by loosening the nuts 31a and 31b.

Note that the present invention is by no means restricted to the above embodiment and can be embodied by appropriately modifying the components of the present invention such as the pedal lever and the reverse lever within a range that does not depart from the gist of the present invention.

According to the present invention, the accelerator switch can be easily and effectively installed in the narrow space of the driver's cabin together with the link mechanism , and also does not disturb operation of the accelerator pedal at all.

What is claimed is:

1. An accelerator pedal operation device comprising:
a pedal lever which turns in response to depression of an accelerator pedal;
a link mechanism having a reverse lever, which turns in association with the pedal lever, and is arranged as a unit structure;
an accelerator stroke sensor which detects an amount of rotation of the reverse lever of the link mechanism and controls an amount of fuel injected into an engine; and
an accelerator switch assembled to the link mechanism integrally therewith, the accelerator switch detecting whether or not the accelerator pedal is depressed in association with the pedal lever.

2. An accelerator pedal operation device according to claim 1, wherein the pedal lever comprises:
a boss portion which acts as a center of rotation; and
a first lever and a second lever which extend from the boss portion in two directions,
wherein the reverse lever is coupled with an extending extreme end portion of the first lever; and
the accelerator pedal is coupled with an extending extreme end portion of the second lever, and a operation unit is arranged on a side opposite to the extending extreme end portion across the boss portion, the operation unit operating the accelerator switch.

3. An accelerator pedal operation device according to claim 1, wherein the accelerator switch is arranged so as to move with respect to the link mechanism so that a position of the accelerator switch can be adjusted with respect to the operation unit of the pedal lever.

4. An accelerator pedal operation device according to claim 2, wherein the accelerator switch is arranged so as to move with respect to the link mechanism so that a position of the accelerator switch can be adjusted with respect to the operation unit of the pedal lever.
